(19) United States
(12) Patent Application Publication
(10) Pub. No.: US 2025/0034030 A1
(43) Pub. Date: Jan. 30, 2025

(54) OPTICAL GLASS, OPTICAL ELEMENT, AND OPTICAL DEVICE

(71) Applicant: CDGM GLASS CO., LTD., Chengdu (CN)

(72) Inventors: Liangzhen HAO, Chengdu (CN); Famao YANG, Chengdu (CN); Shuai YUAN, Chengdu (CN); Bo KUANG, Chengdu (CN); Lulu MAO, Chengdu (CN)

(21) Appl. No.: 18/739,588

(22) Filed: Jun. 11, 2024

(30) Foreign Application Priority Data
Jul. 26, 2023 (CN) 202310923917.8

(51) Int. Cl. C03C 3/097; C03C 3/068

(52) U.S. Cl. CPC C03C 3/097; C03C 3/068

(57) ABSTRACT

The present disclosure relates to an optical glass, an optical element, and an optical device. The optical glass includes the following components in molar percentage: 25% to 40% of SiO₂, 1% to 8% of B₂O₃, 1% to 8% of La₂O₃, 1% to 6% of BaO, 5% to 25% of CaO, 5% to 15% of Nb₂O₅, 8% to 20% of TiO₂, and 1.5% to 15% of Li₂O.

### CROSS-REFERENCE TO RELATED APPLICATIONS

This application claims priority under 35 U.S.C. 119 to Chinese Patent Application No. 202310923917.8 filed on Jul. 26, 2023, the contents of which are hereby incorporated by reference in its entirety.

### TECHNICAL FIELD

The present application relates to an optical glass, an optical element, and an optical device.

### BACKGROUND

In an optical system with a long focal length, a large field of view, and a high precision, the secondary spectrum is a main factor affecting the imaging quality, and the correction of the secondary spectrum is a prominent and challenging issue in the design of the long focal optical system. The correction of the secondary spectrum is largely dependent on the choice of a glass material in the optical system. The glass with a high refractive index and a low relative partial dispersion (P_{g,F}) is beneficial to eliminate the secondary spectrum, simplify and optimize the optical system, and improve the imaging quality when it is applied to a coupling lens.

The secondary pressing molding of the optical glass is widely used in the production of the glass element due to its advantages such as a low production cost, a low production difficulty, and an ease of mass production. The secondary pressing molding is a production method that involves heating the glass material placed in a mold to a temperature above the softening point of the glass material and then pressing the glass material into a predetermined shape. The secondary pressing molding of the optical glass often requires to heat the glass to a temperature of 100 to 200° C. above the transition temperature such that the glass has a certain degree of flowability. The glass has a risk of devitrification scrap in the secondary pressing molding if the glass has a poor devitrification resistance.

### SUMMARY

The objective of the present application is to provide an optical glass, an optical element, and an optical device.

The first aspect of the present application provides an optical glass including the following components in molar percentage: 25% to 40% of SiO₂, 1% to 8% of B₂O₃, 1% to 8% of La₂O₃, 1% to 6% of BaO, 5% to 25% of CaO, 5% to 15% of Nb₂O₅, 8% to 20% of TiO₂, and 1.5% to 15% of Li₂O.

In an embodiment, the optical glass further includes the following components in molar percentage: 0% to 5% of Al₂O₃, and/or 0% to 8% of Gd₂O₃, and/or 0% to 8% of Y₂O₃, and/or 0% to 15% of SrO, and/or 0% to 10% of MgO, and/or 0% to 8% of ZnO, and/or 0% to 5% of ZrO₂, and/or 0% to 5% of WO₃, and/or 0% to 5% of Bi₂O₃, and/or 0% to 5% of Ta₂O₅, and/or 0% to 10% of Na₂O, and/or 0% to 10% of K₂O, and/or 0% to 1% of Sb₂O₃.

In an embodiment, the optical glass consists of the following components in molar percentage: 25% to 40% of SiO₂, 1% to 8% of B₂O₃, 1% to 8% of La₂O₃, 1% to 6% of BaO, 5% to 25% of CaO, 5% to 15% of Nb₂O₅, 8% to 20% of TiO₂, 1.5% to 15% of Li₂O, 0% to 5% of Al₂O₃, 0% to 8% of Gd₂O₃, 0% to 8% of Y₂O₃, 0% to 15% of SrO, 0% to 10% of MgO, 0% to 8% of ZnO, 0% to 5% of ZrO₂, 0% to 5% of WO₃, 0% to 5% of Bi₂O₃, 0% to 5% of Ta₂O₅, 0% to 10% of Na₂O, 0% to 10% of K₂O, and 0% to 1% of Sb₂O₃.

In an embodiment, the optical glass includes the following components in molar percentage:
SiO₂+B₂O₃, 27% to 45%, such as 28% to 43%, such as 30% to 41%; and/or
SiO₂+ZrO₂, 25% to 44%, such as 27% to 42%, such as 29% to 40%; and/or
RO, 10% to 40%, such as 12% to 38%, such as 15% to 35%; and/or
Re₂O₃, 1% to 20%, such as 1.2% to 18%, such as 1.5% to 15%; and/or
B₂O₃+La₂O₃, 2% to 14%, such as 3% to 13%, such as 4% to 12%; and/or
B₂O₃+Al₂O₃, 1% to 12%, such as 2% to 11%, such as 3% to 10%;
wherein RO denotes a total amount of BaO, SrO, CaO, and MgO, and Re₂O₃ denotes a total amount of La₂O₃, Gd₂O₃, and Y₂O₃.

In an embodiment, the components of the optical glass satisfy one or more of the following molar ratios:
1) SiO₂/B₂O₃, 3.5 to 38.0, such as 3.8 to 35.0, such as 4.0 to 30.0;
2) (SiO₂+ZrO₂)/(B₂O₃+Li₂O), 1.8 to 15.0, such as 1.9 to 12.0, such as 2.0 to 10.0; 3) (Nb₂O₅+TiO₂+WO₃+Bi₂O₃+Ta₂O₅)/(SiO₂+B₂O₃), 0.3 to 1.8, such as 0.4 to 1.6, such as 0.5 to 1.4;
4) TiO₂/(Nb₂O₅+La₂O₃), 0.35 to 3.2, such as 0.4 to 3, such as 0.5 to 2.8;
5) CaO/RO, 0.25 to 0.95, such as 0.3 to 0.8, such as 0.4 to 0.7;
6) BaO/RO, 0.03 to 0.5, such as 0.04 to 0.4, such as 0.05 to 0.3;
wherein RO is a total amount of BaO, SrO, CaO, and MgO.

In an embodiment, the optical glass includes the following components in molar percentage:
SiO₂, 27% to 38%, such as 29% to 36%; and/or
B₂O₃, 2% to 7%, such as 3% to 6%; and/or
La₂O₃, 2% to 7%, such as 3% to 6%; and/or
BaO, 1.5% to 5%, such as 2% to 4%; and/or
CaO, 7% to 22%, such as 9% to 20%; and/or
Nb₂O₅, 6% to 14%, such as 7% to 13%; and/or
TiO₂, 9% to 19%, such as 10% to 18%; and/or
Li₂O, 2% to 13%, such as 3% to 11%; and/or
Al₂O₃, 0% to 3%; and/or
Gd₂O₃, 0% to 6%, such as 0% to 4%; and/or
Y₂O₃, 0% to 6%, such as 0% to 4%; and/or
SrO, 1% to 14%, such as 2% to 12%; and/or
MgO, 0% to 8%, such as 0% to 5%; and/or
ZnO, 0% to 6%, such as 0% to 4%; and/or
ZrO₂, 0% to 4%, such as 0% to 3%; and/or
WO₃, 0% to 2%; and/or
Bi₂O₃, 0% to 2%; and/or
Ta₂O₅, 0% to 2%; and/or
Na₂O, 0% to 8%, such as 0% to 6%; and/or
K₂O, 0% to 8%, such as 0% to 6%; and/or
Sb₂O₃, 0% to 0.5%, such as 0% to 0.2%.

In an embodiment, the optical glass is free of Al₂O₃ and/or free of WO₃ and/or free of Bi₂O₃ and/or free of Ta₂O₅.

In an embodiment, the refractive index (n_{d}) of the optical glass is 1.87 to 1.93, such as 1.88 to 1.92, such as 1.89 to 1.91. The Abbe number (v_{d}) of the optical glass is 24 to 30, such as 25 to 29, such as 26 to 28.

In an embodiment, the relative partial dispersion (P_{g,F}) of the optical glass is smaller than or equal to 0.6090, such as smaller than or equal to 0.6085, such as smaller than or equal to 0.6080; and/or the internal transmittance (τ₄₀₀) of the optical glass is larger than or equal to 0.68, such as larger than or equal to 0.70, such as larger than or equal to 0.72; and/or the climate resistance (CR) of the optical is class 2 or higher, such as class 1; and/or the acid resistance stability of the optical glass is class 2 or higher, such as class 1; and/or the density of the optical glass is smaller than or equal to 3.95 g/cm³, such as smaller than or equal to 3.90 g/cm³, such as smaller than or equal to 3.85 g/cm³.

The second aspect of the present application provides a glass preform which is prepared from the optical glass in the first aspect of the present application.

The third aspect of the present application provides an optical element which is prepared from the optical glass in the first aspect of the present application or the glass preform in the second aspect of the present application.

The fourth aspect of the present application provides an optical device which includes the optical glass in the first aspect of the present application and/or the optical element in the third aspect of the present application.

### DETAILED DESCRIPTION

Embodiments of the optical glass of the present application will be described in detail below. However, the present application is not limited to the following embodiments, but may be implemented with appropriate modifications within the scope of the present application. Furthermore, with respect to the repeatedly described amounts, although appropriate omissions may be made sometimes, the subject matter of the present application is not limited thereto. The optical glass of the present application is sometimes referred to simply as the glass hereafter.

### I. Optical Glass

The components (ingredients) of the optical glass of the present application will be described below. Unless otherwise specified herein, an amount or a total amount of component(s) is expressed in a molar percentage (mol %). Specifically, an amount or a total amount of component(s) in a molar percentage is based on the oxide composition of the glass material obtained by conversion. The “oxide composition of the glass material obtained by conversion” is the composition of the glass material achieved by converting raw materials such as an oxide, a complex salt, and a hydroxide of the glass into their respective oxides, assuming those raw materials are molten and decomposed into their respective oxides, with the total amount in molar of all oxides as 100%.

Unless otherwise noted in specific circumstances, the numerical range listed herein includes the upper and lower limits, and the words “above” and “below” include the endpoint values as well as all integers and fractions within the range, but not limited to the specific values listed when the range is defined. The term “and/or” used herein is inclusive. For example, the phrase “A and/or B” includes only A, only B, and both A and B.

### Essential Components and Optional Components

SiO₂, which is a glass network formation body, has an effect of improving the devitrification resistance of the glass. If the amount of SiO₂ is less than 25%, it is difficult to achieve the above effect. Therefore, the lower limit of the amount of SiO₂ is 25%, such as 27%, such as 29%. If the amount of SiO₂ is higher than 40%, the glass becomes difficult to melt to obtain the refractive index as desired in the present application. Therefore, the upper limit of the amount of SiO₂ is 40%, such as 38%, such as 36%.

B₂O₃ can reduce the melting difficulty of the glass, as well as reduce the high-temperature viscosity and the transition temperature of the glass. The inventors have found that the inclusion of a small amount of B₂O₃ in the glass of the present application can significantly improve the devitrification resistance of the glass. However, in the present application, if the amount of B₂O₃ is too high, a reduced chemical stability of the glass will be caused, especially a reduced acid resistance of the glass. Therefore, the amount of B₂O₃ in the present application is 1% to 8%, such as 2% to 7%, such as 3% to 6%.

Both SiO₂ and B₂O₃ function as a glass network in the present application. If the total amount of SiO₂ and B₂O₃ is too high, it will be difficult to achieve a high refractive property of the glass, and if the total amount of SiO₂ and B₂O₃ is too low, the devitrification resistance of the glass will be compromised. Therefore, the total amount of SiO₂ and B₂O₃ is, for example, 27% to 45%, such as 28% to 43%, such as 30% to 41%.

In some embodiments of the present application, the molar ratio of SiO₂ to B₂O₃ is controlled in the range of 3.5 to 38.0, which is beneficial for achieving both excellent chemical stability and excellent devitrification resistance of the glass. Therefore, the molar ratio of SiO₂ to B₂O₃ is, for example, 3.5 to 38.0, such as 3.8 to 35.0, such as 4.0 to 30.0.

Al₂O₃ can improve the climate resistance of the glass, but will cause increased melting temperature and high-temperature viscosity of the glass, thereby increasing the production difficulty of the glass. If the amount of Al₂O₃ is more than 5%, the glass tends to have decreased melting property and decreased devitrification resistance. Therefore, the amount of Al₂O₃ in the present application is 0% to 5%, such as 0% to 3%, such as 0%.

In some embodiments of the present application, the total amount of B₂O₃ and Al₂O₃ is controlled in a range of 1% to 12%, which is beneficial to keep the relative partial dispersion of the glass within the designed range. Therefore, the total amount of B₂O₃ and Al₂O₃ is 1% to 12%, such as 2% to 11%, such as 3% to 10%.

La₂O₃, which is a high refraction and low dispersion component, can greatly reduce the relative partial dispersion of the glass. However, if the amount of La₂O₃ is too high, the acid resistance of the glass will be compromised. Therefore, the amount of La₂O₃ in the present application is 1% to 8%, such as 2% to 7%, such as 3% to 6%.

B₂O₃ and La₂O₃ have strong corrosion to the glass melting furnace in the production. Limiting the total amount of B₂O₃ and La₂O₃ can prolong the service life of the glass melting furnace, reduce the production difficulty of the glass, and improve the quality of the glass. In addition, the inventors have found that B₂O₃ and La₂O₃ have a great effect on the acid resistance of the glass in the present application. If the total amount of B₂O₃ and La₂O₃ is too high, the acid resistance of the glass will be compromised. Therefore, the total amount of B₂O₃ and La₂O₃ is such as 2% to 14%, such as 3% to 13%, such as 4% to 12%.

Gd₂O₃, which is a high refraction and low dispersion component, have an effect of reducing the relative partial dispersion of the glass. However, the raw material of Gd₂O₃ is expensive, limiting the use of Gd₂O₃ in the glass. Therefore, the amount of Gd₂O₃ is 0% to 8%, such as 0% to 6%, such as 0% to 4%.

Y₂O₃ can improve both the melting property and the climate resistance of the glass. However, if the amount of Y₂O₃ is too high, a decreased devitrification resistance of the glass will be caused. Therefore, the amount of Y₂O₃ is 0% to 8%, such as 0% to 6%, such as 0% to 4%.

La₂O₃, Gd₂O₃, or Y₂O₃ has an effect of improving the refractive index and reducing the relative partial dispersion of the glass. However, if the amount of La₂O₃, Gd₂O₃, or Y₂O₃ is too low, it is difficult to achieve the high refraction and low dispersion optical properties as desired in the present application, and if the amount of La₂O₃, Gd₂O₃, or Y₂O₃ is too high, the devitrification resistance of the glass will be compromised. Therefore, the amount of Re₂O₃, i.e., the total amount of La₂O₃, Gd₂O₃, and Y₂O₃, is, for example, 1% to 20%, such as 1.2% to 18%, such as 1.5% to 15% in the present application.

The raw material of BaO is cheap and easy to obtain, and BaO can improve the refractive index of the glass well. However, BaO is unfavorable for reducing the density of the glass. In addition, if the amount of BaO is too high, the climate resistance of the glass will be compromised. Therefore, the amount of BaO is limited to 1% to 6%, such as 1.5% to 5%, such as 2% to 4%.

SrO in an appropriate amount can improve the climate resistance of the glass and reduce the density of the glass. However, SrO is expensive and will cause an increased cost of the glass if its amount is too high. Therefore, the amount of SrO is limited to 0% to 15%, such as 1% to 14%, such as 2% to 12%.

CaO can improve the hardness, the mechanical strength, and the climate resistance of the glass. The inventors have found that CaO is more effective in reducing the density of glass than BaO and SrO. In addition, CaO is also beneficial to control and adjust the optical constant during the production. However, an excessive amount of CaO will cause the melting difficulty of the glass and the tendency to form a calcium-rich crust in the melting pool during production. Therefore, the amount of CaO is limited to 5% to 25%, such as 7% to 22%, such as 9% to 20%.

MgO is conducive to improving the climate resistance of the glass. However, if the amount of MgO is high, the refractive index of the glass will be difficult to meet the design requirements, both the devitrification resistance and the stability of glass will be decreased, and the cost of the glass will be significantly increased. Therefore, the amount of MgO is limited to 0% to 10%, such as 0% to 8%, such as 0% to 5%.

BaO, SrO, CaO, and MgO are all alkaline earth metal oxides. In order to obtain the excellent devitrification resistance and mechanical strength, the amount of RO, i.e., the total amount of the alkaline earth metal oxides BaO, SrO, CaO, and MgO, is, for example, 10% to 40%, such as 12% to 38%, such as 15% to 35%.

In the present application, the relative amounts between the alkaline earth metal oxides are controlled to reduce the density of the glass and improve the devitrification resistance, the stability, and other properties of the glass. In some embodiments, the molar ratio of CaO to RO is controlled in a range of 0.25 to 0.95, which can reduce the density of the glass and improve the devitrification resistance and the acid resistance of the glass. Therefore, the molar ratio of CaO to RO is, for example 0.25 to 0.95, such as 0.3 to 0.8, such as 0.4 to 0.7. In some embodiments, the molar ratio of BaO to RO is controlled in the range of 0.03 to 0.5, which is beneficial to improve the devitrification resistance of the glass. Therefore, the molar ratio of BaO to RO is, for example, 0.03 to 0.5, such as 0.04 to 0.4, such as 0.05 to 0.3.

ZnO can improve the acid resistance stability of the glass, enhance the climate resistance of the glass, and reduce the transition temperature of the glass. However, if the amount of ZnO is too high, the corrosion to a platinum vessel in the melting process will be increased and the service life of the furnace will be reduced. Therefore, the amount of ZnO of the glass in the present application is 0% to 8%, such as 0% to 6%, such as 0% to 4%.

ZrO₂ can improve the climate resistance of the glass and enhance the devitrification resistance of the glass. In addition, ZrO₂ in the glass can greatly reduce the relative partial dispersion of the glass. However, the solubility of ZrO₂ in the glass system the is not high. If the amount of ZrO₂ is too high, ZrO₂ is easy to precipitate out of the glass system to form a devitrification nuclei, causing a deterioration of the devitrification resistance of the glass. Therefore, the amount of ZrO₂ is 0% to 5%, such as 0% to 4%, such as 0% to 3% in the present application.

Both SiO₂ and ZrO₂ can improve the acid resistance of the glass. However, both SiO₂ and ZrO₂ are two components which are difficult to melt in the present application. The inventors have found through extensive experimental research that by controlling the total amount of SiO₂ and ZrO₂ in the range of 25% to 44%, both an excellent acid resistance and a good producibility of the glass can be achieved. Therefore, the total amount of SiO₂ and ZrO₂ is, for example 25% to 44%, such as 27% to 42%, such as 29% to 40%.

Nb₂O₅ is an essential component of the glass in the present application and is a key component to ensure that the glass can have a high refractive index, a low dispersion, a low density, and a low relative partial dispersion. The inventors have found through intensive research that when the Abbe number of the glass is in the range of 24 to 30, the contribution of Nb₂O₅ to the relative partial dispersion of the glass is approximately the same as that to the Abbe number, that is, with the increase of Nb₂O₅ in glass, the relative partial dispersion deviation value (ΔP_{g,F}) of glass basically does not change. Therefore, the amount of Nb₂O₅ is 5% to 15%, such as 6% to 14%, such as 7% to 13% in the present application.

TiO₂ can increase the refractive index and the dispersion of the glass and improve the devitrification resistance of the glass. However, the presence of TiO₂ in the glass will cause a sharp increase in P_{g,F}. If the amount of TiO₂ in the glass is higher than 20%, the P_{g,F} property of the glass will be difficult to meet the design requirement; and if the amount of TiO₂ in the glass is lower than 8%, the high refractive property of the glass will be difficult to meet the design requirement. Therefore, the amount of TiO₂ is 8% to 20%, such as 9% to 19%, such as 10% to 18%.

TiO₂, Nb₂O₅, and La₂O₃ all have an effect of improving the refractive index of the glass in the present application. However, TiO₂ will cause a sharp increase in P_{g,F}. The effects of Nb₂O₅ and La₂O₃ on P_{g,F} of the glass are less than TiO₂. In the present application, by limiting the molar ratio TiO₂/(Nb₂O₅+La₂O₃), i.e., the ratio of the amount of TiO₂ to the total amount of Nb₂O₅ and La₂O₃, to 0.35 to 3.2, the refractive index and P_{g,F} of the glass can meet the design requirements. Therefore, the molar ratio TiO₂/(Nb₂O₅+La₂O₃) is, for example. 0.35 to 3.2, such as 0.4 to 3.0, such as 0.5 to 2.8.

WO₃ can improve the refractive index and the dispersion of the glass, but will cause a sharp increase in P_{g,F} of the glass and a decrease of the light transmittance of the glass. Therefore, the amount of WO₃ is 0% to 5%, such as 0% to 2%, such as 0% in the present application.

Bi₂O₃ can improve the refractive index and the dispersion of the glass, but will cause a sharp increase in P_{g,F} of the glass. In addition, Bi₂O₃ seriously corrodes the platinum vessel during melting. Therefore, the amount of Bi₂O₃ is limited to 0% to 5%, such as 0% to 2%, such as 0%.

Ta₂O₅, which is a high refraction and low dispersion component, can reduce the P_{g,F} value of the glass. In addition, Ta₂O₅ can improve the devitrification resistance of the glass and enhance the stability of the glass. However, the raw material of Ta₂O₅ is expensive, greatly limiting the use of Ta₂O₅. In the present application, the amount of Ta₂O₅ is 0% to 5%, such as 0% to 2%, such as 0%.

Nb₂O₅, TiO₂, WO₃, Bi₂O₃, and Ta₂O₅ can increase the refractive index of the glass. However, the carrying capacities of these components in the glass network are not strong, and the devitrification resistance will be compromised if the amount thereof is too high. The inventors have found through extensive experimental studies that when the ratio of (Nb₂O₅+TiO₂+WO₃+Bi₂O₃+Ta₂O₅) to (SiO₂+B₂O₃), i.e., the ratio of the total amount of Nb₂O₅, TiO₂, WO₃, Bi₂O₃, and Ta₂O₅ to the total amount of SiO₂ and B₂O₃, is in the range of 0.3 to 1.8, the glass can obtain excellent melting property and devitrification resistance. Therefore, the ratio of (Nb₂O₅+TiO₂+WO₃+Bi₂O₃+Ta₂O₅) to (SiO₂+B₂O₃) is, for example, 0.3 to 1.8, such as 0.4 to 1.6, such as 0.5 to 1.4.

Li₂O, which is an alkali metal oxide, is a key component for reducing the production difficulty of the glass in the present application. Li₂O can be used as a fluxing agent to reduce the melting difficulty of the glass. In addition, Li₂O can reduce the high-temperature viscosity and the transition temperature of the glass, making the production and processing of the glass easier. The inventors have found through intensive researches that by containing Li₂O in the glass, the climate resistance of the glass can be improved due to an accumulation effect of Li₂O. However, if the amount of Li₂O is too high, the acid resistance stability of the glass will be decreased. Therefore, in the glass of the present application, the amount of Li₂O is 1.5% to 15%, such as 2% to 13%, such as 3% to 11%.

In the present application, SiO₂ and ZrO₂ can improve the acid resistance of the glass, but are two components that are difficult to melt. B₂O₃ and Li₂O have a fluxing effect, but will cause decreased chemical stability of the glass if the amount of them is too high. The inventors have found through intensive experimental researches that when the ratio of (SiO₂+ZrO₂) to (B₂O₃+Li₂O), i.e., the ratio of the total amount of SiO₂ and ZrO₂ to the total amount of B₂O₃ and Li₂O, is between 1.8 and 15.0, the glass can obtain excellent melting performance and chemical stability. Therefore, the ratio of (SiO₂+ZrO₂) to (B₂O₃+Li₂O) is, for example, 1.8 to 15.0, such as 1.9 to 12.0, such as 2.0 to 10.0.

Na₂O and K₂O can also reduce the melting temperature and the high-temperature viscosity of the glass to reduce the production difficulty of the glass. However, as compared with the accumulation effect of Li₂O, Na₂O and K₂O will cause the breakage of the silicon network structure of the glass and the increase in P_{g,F} of the glass. Therefore, in the glass of the present application, the amount of Na₂O is 0% to 10%, such as 0% to 8%, such as 0% to 6%; and the amount of K₂O is 0% to 10%, such as 0% to 8%, such as 0% to 6%.

In the present application, Sb₂O₃ can be used as a clarifying agent to improve the clarification effect of the glass. The amount of Sb₂O₃ is 0% to 1%, such as 0% to 0.5%, such as 0% to 0.2%.

### Unnecessary Components

In the glass of the present application, the inclusion of oxides of transition metals such as V, Cr, Mn, Fe, Co, Ni, Cu, Ag, and Mo, even in minimum amount individually or combined, will cause the glass to be colored and absorb lights at a specific wavelength in the visible light region, thereby impairing the effects of increasing the visible light transmittance in the present application. Therefore, it is preferable for the glass to be devoid of these oxides, especially for the optical glass having specific requirements on the transmittance of lights at the wavelength in the visible region.

In recent years, there has been a trend towards controlled use of oxides of Th, Cd, Tl, Os, Be, and Se as harmful chemical substances. Environmental protection measures are essential not only in the manufacturing stage of the glass, but also in the processing stage of the glass and the disposal after productization. Therefore, given the emphasis on environmental impact, it is preferable for these oxides to be practically absent, except for unavoidable inclusion. Consequently, the optical glass essentially excludes substances that pollute the environment. As a result, the optical glass of the present application can be manufactured, processed, and disposed of without the need for the specific environmental precautions.

In order to achieve the environmental friendliness, the optical glass in the present application is free of As₂O₃ or PbO. Although As₂O₃ has effects of eliminating bubbles and preventing glass coloration, the addition of As₂O₃ will increase the erosion of the glass to the furnace, especially to the platinum furnace, resulting in more platinum ions entering the glass, negatively impacting the service life of the platinum furnace. PbO can significantly improve the high refractive index and the high dispersion performance of the glass. However, the presence of both PbO and As₂O₃ can contribute to the environmental pollution.

The terms such as “free of” and “0%” as used herein mean that the listed compound, molecule, or element is not intentionally introduced as a raw material into the optical glass of the present application, but may be unintentionally introduced in small or trace amount into the present application as such impurity or component is unintentionally present in the raw materials and/or equipment for producing the optical glass. This situation also falls within the protection scope of the present application.

The properties of the optical glass provided in the present application will be described below.

### Refractive Index and Abbe Number

The refractive index (n_{d}) and the Abbe number (v_{d}) of the optical glass are determined according to the method specified in GB/T 7962.1-2010.

In some embodiments, the refractive index (n_{d}) of the optical glass of the present application is 1.87 to 1.93, such as 1.88 to 1.92, such as 1.89 to 1.91.

In some embodiments, the Abbe number (v_{d}) of the optical glass of the present application is 24 to 30, such as 25 to 29, such as 26 to 28.

### Relative Partial Dispersion

The relative partial dispersion (P_{g,F}) of the optical glass is calculated according to the following equation: P_{g,F}=(n_{g}-n_{F})/(n_{F}-n_{C}), wherein n_{g}, n_{F}, and n_{C} are determined according to the method specified in GB/T 7962.1-2010.

In some embodiments, the relative partial dispersion (P_{g,F}) of the optical glass of the present application is smaller than or equal to 0.6090, such as smaller than or equal to 0.6085, such as smaller than or equal to 0.6080.

### Internal Transmittance

The internal transmittance (τ₄₀₀) of the glass is determined according to the method specified in GB/T 7962.12-2010, at a wavelength of 400 nm, with a sample thickness of 10 mm.

In some embodiments, the internal transmittance (τ₄₀₀) of the optical glass of the present application is 0.68 or higher, such as 0.70 or higher, such as 0.72 or higher.

### Devitrification Resistance

The devitrification resistance of the optical glass is determined as follows: the sample is placed in a muffle furnace at a temperature of T_{g}+230° C. for 15 minutes, taken out and cooled at room temperature, and then polished at two sides, after which the number (A) of devitrified particles per cubic centimeter in the sample is observed.

In some embodiments, the number of the devitrified particles (A) in the optical glass of the present application are 5 or less, such as 3 or less, such as 0.

### Climate Resistance

The Climate Resistance (CR) of the glass is determined as follows: the sample is placed in a test box with a saturated water vapor environment at a relative humidity of 90%, and cycled alternately every 1 hour at 40 to 50° C. for 15 cycles. The climate resistance is classified based on the change in turbidity before and after the sample placement. The climate resistance classification is shown in the table below.

| | | | | 4 | | |
|---|---|---|---|---|---|---|
| Class | 1 | 2 | 3 | a | b | c |
| Increase in turbidity | <0.3 | 0.3-1.0 | 1.0-2.0 | 2.0-4.0 | 4.0-6.0 | ≥6.0 |
| ΔH(%) | | | | | | |

In some embodiments, the climate resistance (CR) of the optical glass of the present application is class 2 or higher, such as class 1.

### Acid Resistance Stability

The acid resistance stability RA(S) of the glass is determined according to the method specified in GB/T 7962.14-2010.

In some embodiments, the acid resistance stability of the optical glass of the present application is class 2 or higher, such as class 1.

### Density

The density (ρ) of the glass is determined according to the method specified in GB/T 7962.20-2010.

In some embodiments, the density (ρ) of the optical glass of the present application is 3.95 g/cm³ or larger, such as 3.90 g/cm³ or larger, such as 3.85 g/cm³ or larger.

### Manufacturing Method

The manufacturing method of the optical class in the present application is as follows. The glass of the present application is produced by a conventional process using conventional raw materials. Specifically, raw materials, such as a complex slat (e.g., carbonate, nitrate, sulfate), a hydroxide, and an oxide, were formulated by a conventional method and placed into a melting furnace at 1250 to 1450° C. to be melted. A homogeneous melted glass without bubbles and undissolved substances is obtained after clarification, stirring, and homogenization. The melted glass is casted in a mold and annealed to form the optical class. Raw materials, the manufacturing process, and process parameters may be appropriately selected by those skilled in the art according to actual needs.

### II. Glass Preform and Optical Element

The glass preform may be made from the optical glass by grinding, hot-pressing, precision stamping, or other pressing molding methods. More specifically, the optical glass may be machined, for example, milled or grinded to prepare the glass preform. Alternatively, the optical glass may be formed into a preform for pressing molding, which is then hot-pressed and grinded to prepare the glass preform. Alternatively, the optical glass may be grinded to obtain a preform, which is then precision-stamped to prepare the glass preform. It should be noted that the preparation method of the glass preform is not limited to the above methods.

As mentioned above, the optical glass of the present application is useful for various optical elements and optical designs. In some embodiments, the optical glass of the present application is formed into a preform which is then subjected to hot-pressing, precision-stamping, or other molding methods to prepare the optical elements such as lens and prism.

The glass preform or the optical element of the present application is formed from the optical glass of the present application as described above. The glass preform of the present application has excellent properties inherent in the optical glass. The optical element of the present application has excellent properties inherent in the optical glass. The present application can provide optical elements of high optical values, such as lenses and prisms.

Examples of the lens include various lenses with spherical or aspheric surfaces, such as concave meniscus lens, convex meniscus lens, biconvex lens, biconcave lens, planoconvex lens, and planoconcave lens.

### III. Optical Device

An optical device, such as an imaging device, an on-board device, a camera, a display device, and a monitoring device, can be prepared from the optical glass of the present application.

The optical glass of the present application is especially applicable to a telephoto lens or a high-definition interchangeable lens due to its high refraction and low relative partial dispersion properties.

### EXAMPLES

### Examples of Optical Glass

The following non-limiting examples are provided to further illustrate and described the technical solutions of the present application.

The optical glasses as shown in Tables 1 to 4 were prepared by the manufacturing method of the optical glass as described above. In addition, the properties of the glasses were determined by the test method as described in the present application, and the results are shown in Tables 1 to 4.

TABLE 1

| Components | | | | | | | | | | |
|---|---|---|---|---|---|---|---|---|---|---|
| (mol %) | 1# | 2# | 3# | 4# | 5# | 6# | 7# | 8# | 9# | 10# |
| SiO₂ | 30.12 | 36.47 | 32.24 | 37.87 | 31.42 | 33.76 | 31.04 | 35.24 | 34.54 | 25.21 |
| B₂O₃ | 1.62 | 2.35 | 4.24 | 2.54 | 4.78 | 7.15 | 5.78 | 6.54 | 3.75 | 5.25 |
| Al₂O₃ | 0 | 0 | 0 | 2.65 | 0 | 0 | 0 | 2.14 | 0 | 0.34 |
| La₂O₃ | 1.24 | 2.24 | 3.24 | 1.74 | 4.78 | 5.54 | 2.58 | 3.74 | 4.15 | 4.58 |
| Gd₂O₃ | 0 | 2.24 | 3.21 | 7.05 | 0 | 0 | 0 | 4.14 | 0 | 0 |
| Y₂O₃ | 6.25 | 0 | 0 | 0 | 0.45 | 0 | 0 | 0 | 0 | 0 |
| BaO | 2.75 | 3.81 | 1.71 | 3.54 | 2.21 | 1.92 | 3.45 | 1.24 | 3.15 | 5.87 |
| SrO | 0 | 11.24 | 13.42 | 4.24 | 10.1 | 0 | 10.21 | 0 | 2.54 | 7.25 |
| CaO | 19.58 | 5.21 | 7.21 | 6.45 | 13.54 | 5.58 | 10.98 | 24.15 | 11.53 | 12.32 |
| MgO | 5.24 | 0 | 0 | 0.54 | 0 | 9.54 | 0 | 0 | 0.98 | 4.45 |
| ZnO | 0 | 0 | 0 | 2.74 | 0 | 0 | 0 | 5.78 | 0 | 0 |
| ZrO₂ | 1.87 | 0 | 0.24 | 0.67 | 2.32 | 0.64 | 1.98 | 0 | 1.24 | 4.58 |
| Nb₂O₅ | 8.04 | 0 | 6.54 | 11.24 | 9.25 | 6.14 | 8.23 | 5.26 | 10.24 | 14.57 |
| TiO₂ | 10.14 | 18.25 | 12.77 | 17.15 | 16.27 | 19.75 | 14.78 | 9.63 | 11.75 | 8.57 |
| WO₃ | 2.47 | 3.57 | 0 | 0 | 0 | 0 | 0 | 0 | 0 | 1.35 |
| Bi₂O₃ | 0 | 0 | 2.28 | 0 | 0 | 0 | 0 | 0 | 3.14 | 0 |
| Ta₂O₅ | 0 | 0 | 0 | 0 | 0 | 0 | 0 | 0 | 0 | 0 |
| Li₂O | 10.58 | 14.57 | 5.2 | 1.58 | 4.78 | 2.58 | 6.54 | 2.14 | 12.74 | 4.58 |
| Na₂O | 0 | 0 | 4.36 | 0 | 0 | 0 | 4.33 | 0 | 0 | 0 |
| K₂O | 0 | 0 | 3.24 | 0 | 0 | 7.25 | 0 | 0 | 0 | 1.04 |
| Sb₂O₃ | 0.1 | 0.05 | 0.1 | 0 | 0.1 | 0.15 | 0.1 | 0 | 0.25 | 0.04 |
| Total | 100 | 100 | 100 | 100 | 100 | 100 | 100 | 100 | 100 | 100 |
| SiO₂ + B₂O₃ | 31.74 | 38.82 | 36.48 | 40.41 | 36.2 | 40.91 | 36.82 | 41.78 | 38.29 | 30.46 |
| SiO₂/B₂O₃ | 18.59 | 15.52 | 7.60 | 14.91 | 6.57 | 4.72 | 5.37 | 5.39 | 9.21 | 4.80 |
| SiO₂ + ZrO₂ | 31.99 | 36.47 | 32.48 | 38.54 | 33.74 | 34.4 | 33.02 | 35.24 | 35.78 | 29.79 |
| RO | 27.57 | 20.26 | 22.34 | 14.77 | 25.85 | 17.04 | 24.64 | 25.39 | 18.2 | 29.89 |
| Re₂O₃ | 7.49 | 4.48 | 6.45 | 8.79 | 5.23 | 5.54 | 2.58 | 7.88 | 4.15 | 4.58 |
| B₂O₃ + La₂O₃ | 2.86 | 4.59 | 7.48 | 4.28 | 9.56 | 12.69 | 8.36 | 10.28 | 7.9 | 9.83 |
| (SiO₂ + ZrO₂)/ | 2.62 | 2.16 | 3.44 | 9.35 | 3.53 | 3.54 | 2.68 | 4.06 | 2.17 | 3.03 |
| (B₂O₃ + Li₂O) | | | | | | | | | | |
| (Nb₂O₅ + TiO₂ + | 0.65 | 0.56 | 0.59 | 0.70 | 0.70 | 0.63 | 0.62 | 0.36 | 0.66 | 0.80 |
| WO₃ + Bi₂O₃ + | | | | | | | | | | |
| Ta₂O₅)/(SiO₂ + B₂O₃) | | | | | | | | | | |
| B₂O₃ + Al₂O₃ | 1.62 | 2.35 | 4.24 | 5.19 | 4.78 | 7.15 | 5.78 | 8.68 | 3.75 | 5.59 |
| TiO₂/(Nb₂O₅ + La₂O₃) | 1.09 | 8.15 | 1.31 | 1.32 | 1.16 | 1.69 | 1.37 | 1.07 | 0.82 | 0.45 |
| CaO/RO | 0.71 | 0.26 | 0.32 | 0.44 | 0.52 | 0.33 | 0.45 | 0.95 | 0.63 | 0.41 |
| BaO/RO | 0.10 | 0.19 | 0.08 | 0.24 | 0.09 | 0.11 | 0.14 | 0.05 | 0.17 | 0.20 |
| n_{d} | 1.87124 | 1.88865 | 1.89205 | 1.89254 | 1.90357 | 1.91124 | 1.91105 | 1.90241 | 1.88257 | 1.87425 |
| v_{d} | 28.69 | 29.87 | 27.87 | 26.84 | 27.15 | 25.97 | 28.24 | 24.74 | 29.31 | 25.47 |
| P_{g.F} | 0.6071 | 0.6053 | 0.6072 | 0.6081 | 0.6074 | 0.6068 | 0.6067 | 0.6075 | 0.608 | 0.6089 |
| τ₄₀₀ | 0.81 | 0.74 | 0.81 | 0.78 | 0.84 | 0.77 | 0.81 | 0.81 | 0.70 | 0.80 |
| A(number of | 0 | 0 | 0 | 0 | 0 | 2 | 0 | 0 | 4 | 0 |
| particles) | | | | | | | | | | |
| CR class | 1 | 2 | 1 | 1 | 1 | 1 | 1 | 1 | 1 | 2 |
| RA class | 1 | 1 | 1 | 1 | 1 | 1 | 1 | 1 | 1 | 1 |
| ρ(g/cm³) | 3.81 | 3.80 | 3.79 | 3.88 | 3.80 | 3.83 | 3.84 | 3.84 | 3.76 | 3.88 |

TABLE 2

| Components | | | | | | | | | | |
|---|---|---|---|---|---|---|---|---|---|---|
| (mol %) | 11# | 12# | 13# | 14# | 15# | 16# | 17# | 18# | 19# | 20# |
| SiO₂ | 32.88 | 35.47 | 33.74 | 32.45 | 32.04 | 33.45 | 26.24 | 27.34 | 34.54 | 33.21 |
| B₂O₃ | 3.98 | 3.78 | 4.98 | 4.45 | 2.24 | 3.75 | 1.25 | 3.21 | 5.54 | 5.21 |
| Al₂O₃ | 0 | 0 | 0 | 0 | 0 | 0 | 0 | 1.24 | 0 | 0 |
| La₂O₃ | 4.21 | 3.67 | 5.24 | 3.75 | 5.95 | 3.75 | 1.15 | 2.25 | 3.87 | 5.47 |
| Gd₂O₃ | 0 | 0 | 0 | 0 | 0 | 0 | 0 | 1.25 | 0 | 0 |
| Y₂O₃ | 0 | 0 | 0 | 0 | 0 | 1.84 | 7.52 | 2.32 | 0 | 0 |
| BaO | 2.25 | 3.87 | 3.78 | 2.87 | 1.11 | 1.87 | 2.54 | 5.64 | 2.98 | 5.21 |
| SrO | 9.45 | 3.24 | 8.21 | 9.75 | 7.24 | 6.38 | 0 | 5.74 | 10.54 | 10.45 |
| CaO | 14.27 | 18.25 | 13.24 | 13.78 | 13.24 | 13.24 | 22.24 | 5.35 | 11.42 | 11.47 |
| MgO | 0 | 3.24 | 0 | 0 | 0 | 0 | 0 | 1.25 | 0 | 0 |
| ZnO | 0 | 0 | 0 | 0 | 0 | 0 | 0 | 0.32 | 0 | 0 |
| ZrO₂ | 2.35 | 0 | 0 | 1.78 | 2.54 | 2.72 | 0 | 1.54 | 0 | 0 |
| Nb₂O₅ | 9.48 | 7.24 | 11.24 | 9.86 | 11.65 | 10.78 | 5.35 | 12.54 | 12.45 | 18.85 |
| TiO₂ | 16.64 | 13.25 | 11.78 | 16.78 | 18.57 | 16.98 | 16.54 | 9.45 | 10.05 | 8.76 |
| WO₃ | 0 | 0 | 0 | 0 | 0 | 0 | 0 | 4.54 | 0 | 0 |
| Bi₂O₃ | 0 | 0 | 0 | 0 | 0 | 0 | 0 | 1.25 | 0 | 0 |
| Ta₂O₅ | 0 | 0 | 0 | 0 | 0 | 0 | 4.67 | 2.14 | 0 | 1.24 |
| Li₂O | 4.39 | 7.89 | 7.69 | 4.43 | 3.74 | 5.14 | 1.89 | 5.45 | 5.54 | 3.25 |
| Na₂O | 0 | 0 | 0 | 0 | 1.58 | 0 | 9.74 | 1.74 | 1.24 | 6.78 |
| K₂O | 0 | 0 | 0 | 0 | 0 | 0 | 0 | 5.34 | 1.73 | 0 |
| Sb₂O₃ | 0.1 | 0.1 | 0.1 | 0.1 | 0.1 | 0.1 | 0.87 | 0.1 | 0.1 | 0.1 |
| Total | 100 | 100 | 100 | 100 | 100 | 100 | 100 | 100 | 100 | 100 |
| SiO₂ + B₂O₃ | 36.86 | 39.25 | 38.72 | 36.9 | 34.28 | 37.2 | 27.49 | 30.55 | 40.08 | 38.42 |
| SiO₂/B₂O₃ | 8.26 | 9.38 | 6.78 | 7.29 | 14.30 | 8.92 | 20.99 | 8.52 | 6.23 | 6.37 |
| SiO₂ + ZrO₂ | 35.23 | 35.47 | 33.74 | 34.23 | 34.58 | 36.17 | 26.24 | 28.88 | 34.54 | 33.21 |
| RO | 25.97 | 28.6 | 25.23 | 26.4 | 21.59 | 21.49 | 24.78 | 17.98 | 24.94 | 27.13 |
| Re₂O₃ | 4.21 | 3.67 | 5.24 | 3.75 | 5.95 | 5.59 | 8.67 | 5.82 | 3.87 | 5.47 |
| B₂O₃ + La₂O₃ | 8.19 | 7.45 | 10.22 | 8.2 | 8.19 | 7.5 | 2.4 | 5.46 | 9.41 | 10.68 |
| (SiO₂ + ZrO₂)/ | 4.21 | 3.04 | 2.66 | 3.85 | 5.78 | 4.07 | 8.36 | 3.33 | 3.12 | 3.93 |
| (B₂O₃ + Li₂O) | | | | | | | | | | |
| (Nb₂O₅ + TiO₂ + | 0.71 | 0.52 | 0.59 | 0.72 | 0.88 | 0.75 | 0.97 | 0.98 | 0.56 | 0.49 |
| WO₃ + Bi₂O₃ + | | | | | | | | | | |
| Ta₂O₅)/(SiO₂ + B₂O₃) | | | | | | | | | | |
| B₂O₃ + Al₂O₃ | 3.98 | 3.78 | 4.98 | 4.45 | 2.24 | 3.75 | 1.25 | 4.45 | 5.54 | 5.21 |
| TiO₂/(Nb₂O₅ + La₂O₃) | 1.22 | 1.21 | 0.71 | 1.23 | 1.06 | 1.17 | 2.54 | 0.64 | 0.62 | 0.61 |
| CaO/RO | 0.55 | 0.64 | 0.52 | 0.52 | 0.61 | 0.62 | 0.90 | 0.30 | 0.46 | 0.42 |
| BaO/RO | 0.09 | 0.14 | 0.15 | 0.11 | 0.05 | 0.09 | 0.10 | 0.31 | 0.12 | 0.19 |
| n_{d} | 1.89865 | 1.90687 | 1.91214 | 1.9034 | 1.90245 | 1.90524 | 1.92547 | 1.88854 | 1.91967 | 1.89987 |
| v_{d} | 26.94 | 27.64 | 27.24 | 27.34 | 27.64 | 27.35 | 27.21 | 26.47 | 27.39 | 28.21 |
| P_{g.F} | 0.6071 | 0.6068 | 0.6071 | 0.6072 | 0.6072 | 0.6073 | 0.6087 | 0.6074 | 0.6073 | 0.6067 |
| τ₄₀₀ | 0.78 | 0.82 | 0.75 | 0.75 | 0.77 | 0.81 | 0.81 | 0.79 | 0.76 | 0.81 |
| A(number of | 0 | 0 | 0 | 0 | 0 | 1 | 0 | 0 | 2 | 0 |
| particles) | | | | | | | | | | |
| CR class | 1 | 1 | 1 | 1 | 1 | 2 | 1 | 1 | 1 | 1 |
| RA class | 1 | 1 | 1 | 2 | 1 | 2 | 1 | 1 | 1 | 1 |
| ρ(g/cm³) | 3.84 | 3.85 | 3.85 | 3.84 | 3.79 | 3.79 | 3.82 | 3.86 | 3.80 | 3.86 |

TABLE 3

| Components | | | | | | | | | | |
|---|---|---|---|---|---|---|---|---|---|---|
| (mol %) | 21# | 22# | 23# | 24# | 25# | 26# | 27# | 28# | 29# | 30# |
| SiO₂ | 34.24 | 33.24 | 33.05 | 31.55 | 39.76 | 28.45 | 32.01 | 31.75 | 29.13 | 31.25 |
| B₂O₃ | 3.25 | 3.35 | 4.05 | 1.78 | 1.12 | 1.97 | 2.78 | 6.14 | 7.47 | 4.68 |
| Al₂O₃ | 0 | 0 | 0 | 4.54 | 3.25 | 0 | 0 | 0 | 0 | 0 |
| La₂O₃ | 4.34 | 4.32 | 4.05 | 7.24 | 1.25 | 1.47 | 5.85 | 6.45 | 7.64 | 4.87 |
| Gd₂O₃ | 0 | 1.64 | 0 | 0 | 0 | 6.54 | 0 | 0 | 0 | 0 |
| Y₂O₃ | 2.21 | 0 | 0 | 0 | 0.39 | 0 | 0 | 0 | 0 | 3.15 |
| BaO | 2.75 | 3.24 | 2.2 | 1.54 | 1.54 | 2.01 | 3.25 | 4.58 | 4.54 | 2.87 |
| SrO | 5.28 | 6.75 | 8.25 | 14.24 | 5.24 | 0.45 | 0 | 0 | 0 | 9.24 |
| CaO | 14.35 | 16.75 | 13.25 | 7.25 | 10.24 | 17.58 | 8.54 | 9 | 15.54 | 14.25 |
| MgO | 0 | 4.02 | 2.12 | 0 | 0 | 6.74 | 0 | 9.21 | 3.24 | 0 |
| ZnO | 0 | 0 | 0 | 0 | 1.45 | 2.38 | 7.57 | 0 | 0 | 0 |
| ZrO₂ | 1.75 | 0 | 1.01 | 4.12 | 0 | 1.45 | 2.25 | 3.47 | 0 | 0 |
| Nb₂O₅ | 10.23 | 9.14 | 8.59 | 13.95 | 13.25 | 9.54 | 7.57 | 6.7 | 10.84 | 10.24 |
| TiO₂ | 15.75 | 11.75 | 15.48 | 10.24 | 13.65 | 12.47 | 14.57 | 8.3 | 18.54 | 15.75 |
| WO₃ | 0 | 0 | 0 | 0 | 0 | 0 | 0 | 0 | 0 | 0 |
| Bi₂O₃ | 0 | 0 | 0 | 0 | 0.11 | 0 | 4.47 | 0 | 0 | 0 |
| Ta₂O₅ | 0 | 0 | 0 | 0 | 3.25 | 0 | 0 | 3.78 | 0 | 0 |
| Li₂O | 5.75 | 5.7 | 6.36 | 3.55 | 3.24 | 8.75 | 1.67 | 2.54 | 3.06 | 3.6 |
| Na₂O | 0 | 0 | 1.01 | 0 | 2.21 | 0 | 0 | 7.98 | 0 | 0 |
| K₂O | 0 | 0 | 0.48 | 0 | 0 | 0 | 9.47 | 0 | 0 | 0 |
| Sb₂O₃ | 0.1 | 0.1 | 0.1 | 0 | 0.05 | 0.2 | 0 | 0.1 | 0 | 0.1 |
| Total | 100 | 100 | 100 | 100 | 100 | 100 | 100 | 100 | 100 | 100 |
| SiO₂ + B₂O₃ | 37.49 | 36.59 | 37.1 | 33.33 | 40.88 | 30.42 | 34.79 | 37.89 | 36.6 | 35.93 |
| SiO₂/B₂O₃ | 10.54 | 9.92 | 8.16 | 17.72 | 35.50 | 14.44 | 11.51 | 5.17 | 3.90 | 6.68 |
| SiO₂ + ZrO₂ | 35.99 | 33.24 | 34.06 | 35.67 | 39.76 | 29.9 | 34.26 | 35.22 | 29.13 | 31.25 |
| RO | 22.38 | 30.76 | 25.82 | 23.03 | 17.02 | 26.78 | 11.79 | 22.79 | 23.32 | 26.36 |
| Re₂O₃ | 6.55 | 5.96 | 4.05 | 7.24 | 1.64 | 8.01 | 5.85 | 6.45 | 7.64 | 8.02 |
| B₂O₃ + La₂O₃ | 7.59 | 7.67 | 8.1 | 19.02 | 2.37 | 3.44 | 8.63 | 12.59 | 15.11 | 9.55 |
| (SiO₂ + ZrO₂)/ | 4.00 | 3.67 | 3.27 | 6.69 | 9.12 | 2.79 | 7.70 | 4.06 | 2.77 | 3.77 |
| (B₂O₃ + Li₂O) | | | | | | | | | | |
| (Nb₂O₅ + TiO₂ + | 0.69 | 0.57 | 0.65 | 0.73 | 0.74 | 0.72 | 0.76 | 0.50 | 0.80 | 0.72 |
| WO₃ + Bi₂O₃ + | | | | | | | | | | |
| Ta₂O₅)/(SiO₂ + B₂O₃) | | | | | | | | | | |
| B₂O₃ + Al₂O₃ | 3.25 | 3.35 | 4.05 | 6.32 | 4.37 | 1.97 | 2.78 | 6.14 | 7.47 | 4.68 |
| TiO₂/(Nb₂O₅ + La₂O₃) | 1.08 | 0.87 | 1.22 | 0.48 | 0.94 | 1.13 | 1.09 | 0.63 | 1.00 | 1.04 |
| CaO/RO | 0.64 | 0.54 | 0.51 | 0.31 | 0.60 | 0.66 | 0.72 | 0.39 | 0.67 | 0.54 |
| BaO/RO | 0.12 | 0.11 | 0.09 | 0.07 | 0.09 | 0.08 | 0.28 | 0.20 | 0.19 | 0.11 |
| n_{d} | 1.89987 | 1.90247 | 1.91536 | 1.90785 | 1.88254 | 1.92874 | 1.91987 | 1.90877 | 1.89854 | 1.89647 |
| v_{d} | 26.89 | 27.21 | 27.20 | 25.32 | 25.93 | 28.04 | 26.54 | 28.14 | 27.97 | 26.75 |
| P_{g.F} | 0.6072 | 0.6072 | 0.6075 | 0.6071 | 0.6083 | 0.6070 | 0.6069 | 0.6066 | 0.6078 | 0.6074 |
| τ₄₀₀ | 0.82 | 0.80 | 0.69 | 0.77 | 0.75 | 0.77 | 0.69 | 0.82 | 0.77 | 0.78 |
| A(number of | 0 | 0 | 0 | 1 | 0 | 0 | 0 | 0 | 0 | 0 |
| particles) | | | | | | | | | | |
| CR class | 1 | 1 | 2 | 1 | 1 | 1 | 1 | 1 | 1 | 1 |
| RA class | 1 | 1 | 1 | 1 | 1 | 1 | 2 | 1 | 1 | 1 |
| ρ(g/cm³) | 3.85 | 3.83 | 3.89 | 3.8 | 3.87 | 3.79 | 3.87 | 3.78 | 3.85 | 3.82 |

TABLE 4

| Components | | | | | | | | | | |
|---|---|---|---|---|---|---|---|---|---|---|
| (mol %) | 31# | 32# | 33# | \|34# | 35# | 36# | 37# | 38# | 39# | 40# |
| SiO₂ | 30.24 | 35.42 | 30.67 | 29.51 | 32.54 | 34.14 | 29.47 | 31.25 | 33.47 | 32.47 |
| B₂O₃ | 3.24 | 6.87 | 5.25 | 3.25 | 4.54 | 4.14 | 5.24 | 3.87 | 3.24 | 4.24 |
| Al₂O₃ | 0 | 4.42 | 0 | 0 | 2.58 | 0 | 0 | 0 | 0 | 0 |
| La₂O₃ | 3.24 | 4.21 | 2.86 | 2.42 | 1.6 | 3.54 | 5.45 | 4.56 | 4.75 | 5.78 |
| Gd₂O₃ | 0 | 0 | 0 | 5.62 | 4.21 | 0 | 0 | 0 | 0 | 0 |
| Y₂O₃ | 4.21 | 1.08 | 0 | 0 | 4.21 | 0 | 0 | 5.21 | 0 | 0 |
| BaO | 2.21 | 3.42 | 3.12 | 4.12 | 3.21 | 2.57 | 2.14 | 2.75 | 1.58 | 3.35 |
| SrO | 2.47 | 4.16 | 11.29 | 1.47 | 0 | 9.54 | 11.75 | 4.54 | 8.54 | 6.78 |
| CaO | 19.45 | 12.75 | 14.78 | 13.25 | 7.24 | 11.04 | 12.75 | 17.34 | 12.21 | 15.87 |
| MgO | 0 | 0 | 0 | 0 | 5.14 | 0 | 0 | 0 | 1.92 | 0 |
| ZnO | 0 | 3.25 | 0 | 4.25 | 4.31 | 0 | 0 | 1.32 | 0 | 0 |
| ZrO₂ | 0 | 0 | 1.57 | 0 | 2.57 | 1.57 | 0 | 1.24 | 0.87 | 0 |
| Nb₂O₅ | 7.24 | 12.69 | 8.76 | 13.75 | 10.47 | 9.75 | 12.24 | 8.54 | 10.57 | 9.64 |
| TiO₂ | 17.27 | 9.85 | 17.35 | 15.25 | 9.54 | 16.05 | 17.58 | 15.54 | 17.21 | 13.24 |
| WO₃ | 0 | 0 | 0 | 0 | 0 | 0 | 0 | 0 | 0 | 0 |
| Bi₂O₃ | 0 | 0 | 0 | 0 | 0 | 0 | 0 | 0 | 0 | 0 |
| Ta₂O₅ | 0 | 0 | 0 | 0 | 0 | 0 | 0 | 0 | 0 | 0 |
| Li₂O | 10.33 | 1.78 | 4.25 | 7.01 | 1.55 | 4.54 | 3.28 | 3.74 | 5.54 | 8.53 |
| Na₂O | 0 | 0 | 0 | 0 | 3.95 | 3.02 | 0 | 0 | 0 | 0 |
| K₂O | 0 | 0 | 0 | 0 | 2.24 | 0 | 0 | 0 | 0 | 0 |
| Sb₂O₃ | 0.1 | 0.1 | 0.1 | 0.1 | 0.1 | 0.1 | 0.1 | 0.1 | 0.1 | 0.1 |
| Total | 100 | 100 | 100 | 100 | 100 | 100 | 100 | 100 | 100 | 100 |
| SiO₂ + B₂O₃ | 33.48 | 42.29 | 35.92 | 32.76 | 37.08 | 38.28 | 34.71 | 35.12 | 36.71 | 36.71 |
| SiO₂/B₂O₃ | 9.33 | 5.16 | 5.84 | 9.08 | 7.17 | 8.25 | 5.62 | 8.07 | 10.33 | 7.66 |
| SiO₂ + ZrO₂ | 30.24 | 35.42 | 32.24 | 29.51 | 35.11 | 35.71 | 29.47 | 32.49 | 34.34 | 32.47 |
| RO | 24.13 | 20.33 | 29.19 | 18.84 | 15.59 | 23.15 | 26.64 | 24.63 | 24.25 | 26 |
| Re₂O₃ | 7.45 | 5.29 | 2.86 | 8.04 | 10.02 | 3.54 | 5.45 | 9.77 | 4.75 | 5.78 |
| B₂O₃ + La₂O₃ | 6.48 | 11.08 | 8.11 | 5.67 | 6.14 | 7.68 | 10.69 | 8.43 | 7.99 | 10.02 |
| (SiO₂ + ZrO₂)/ | 2.23 | 4.09 | 3.39 | 2.88 | 5.77 | 4.11 | 3.46 | 4.27 | 3.91 | 2.54 |
| (B₂O₃ + Li₂O) | | | | | | | | | | |
| (Nb₂O₅ + TiO₂ + | 0.73 | 0.53 | 0.73 | 0.89 | 0.54 | 0.67 | 0.86 | 10.69 | 0.76 | 0.62 |
| WO₃ + Bi₂O₃ + | | | | | | | | | | |
| Ta₂O₅)/(SiO₂ + B₂O₃) | | | | | | | | | | |
| B₂O₃ + Al₂O₃ | 3.24 | 11.29 | 5.25 | 3.25 | 7.12 | 4.14 | 5.24 | 3.87 | 3.24 | 4.24 |
| TiO₂/(Nb₂O₅ + La₂O₃) | 1.65 | 0.58 | 1.49 | 0.94 | 0.79 | 1.21 | 0.99 | 1.19 | 1.12 | 0.86 |
| CaO/RO | 0.81 | 0.63 | 0.51 | 0.70 | 0.46 | 0.48 | 0.48 | 0.70 | 0.50 | 0.61 |
| BaO/RO | 0.09 | 0.17 | 0.11 | 0.22 | 0.21 | 0.11 | 0.08 | 0.11 | 0.07 | 0.13 |
| n_{d} | 1.89123 | 1.91245 | 1.89675 | 1.92003 | 1.91035 | 1.90871 | 1.8924 | 1.89877 | 1.90214 | 1.90547 |
| v_{d} | 26.64 | 28.75 | 26.75 | 26.24 | 28.41 | 28.41 | 26.21 | 26.84 | 27.85 | 27.04 |
| P_{g.F} | 0.6060 | 0.6066 | 0.6070 | 0.6084 | 0.6071 | 0.6069 | 0.6076 | 0.6055 | 0.6068 | 0.6074 |
| τ₄₀₀ | 0.71 | 0.72 | 0.83 | 0.83 | 0.83 | 0.82 | 0.76 | 0.82 | 0.78 | 0.81 |
| A(number of | 0 | 0 | 0 | 3 | 1 | 1 | 0 | 0 | 0 | 0 |
| particles) | | | | | | | | | | |
| CR class | 1 | 1 | 1 | 1 | 1 | 1 | 1 | 1 | 2 | 1 |
| RA class | 1 | 1 | 1 | 1 | 1 | 1 | 1 | 1 | 1 | 2 |
| ρ(g/cm³) | 3.83 | 3.81 | 3.80 | 3.84 | 3.84 | 3.80 | 3.83 | 3.82 | 3.85 | 3.81 |

### Examples of Glass Preform

Preforms of lenses and prisms such as concave meniscus lens, convex meniscus lens, biconvex lens, biconcave lens, planoconvex lens, and planoconcave lens were prepared from the glasses obtained in Examples 1 to 40 of the optical glasses by the method such as grinding, hot-pressing, precision stamping, and other pressing molding methods.

### Examples of Optical Element

The preforms obtained in the above examples of glass preform were annealed to reduce the deformations inside the glass and tune the optical properties such the refractive index of the glass to desired values.

Then, the preforms were milled or grinded to prepare lenses and prisms such as concave meniscus lens, convex meniscus lens, biconvex lens, biconcave lens, planoconvex lens, and planoconcave lens. An antireflection film may be coated on the surface of the obtained optical elements.

### Examples of Optical Device

One or more of the optical elements obtained in the above examples of optical element formed an optical component or assembly according to an optical design, which can be used in an optical device such as an imaging device, a sensor, a microscope, a medical device, a digital projector, a communication device, a device for optical communication/information transmission, an optical/lighting device in an automobile, a photoetching device, an excimer laser, a wafer, a computer chip, and an integrated circuit or an electronic device including the circuit or the chip.

The present application provides the following benefits: the optical glass has an excellent devitrification resistance due to the appropriate amounts of the components such as SiO₂ and the alkali metal oxide contained therein; the optical glass has a high refractive index due to the high refractive index components such as Nb₂O₅ and TiO₂ contained therein; and the optical glass has a low relative partial dispersion due to the reasonable design of the composition thereof.

What is claimed is:

1. An optical glass, comprising the following components:
25 mol % to 40 mol % of SiO₂,
1 mol % to 8 mol % of B₂O₃,
1 mol % to 8 mol % of La₂O₃,
1 mol % to 6 mol % of BaO,
5 mol % to 25 mol % of CaO,
5 mol % to 15 mol % of Nb₂O₅,
8 mol % to 20 mol % of TiO₂, and
1.5 mol % to 15 mol % of Li₂O.

2. The optical glass of claim 1, further comprising the following components: 0 mol % to 5 mol % of Al₂O₃, and/or 0 mol % to 8 mol % of Gd₂O₃, and/or 0 mol % to 8 mol % of Y₂O₃, and/or 0 mol % to 15 mol % of SrO, and/or 0 mol % to 10 mol % of MgO, and/or 0 mol % to 8 mol % of ZnO, and/or 0 mol % to 5 mol % of ZrO₂, and/or 0 mol % to 5 mol % of WO₃, and/or 0 mol % to 5 mol % of Bi₂O₃, and/or 0 mol % to 5 mol % of Ta₂O₅, and/or 0 mol % to 10 mol % of Na₂O, and/or 0 mol % to 10 mol % of K₂O, and/or 0 mol % to 1 mol % of Sb₂O₃.

3. The optical glass of claim 1, comprising 27 mol % to 45 mol % of SiO₂+B₂O₃, and/or 25 mol % to 44 mol % of SiO₂+ZrO₂, and/or 10 mol % to 40 mol % of BaO+SrO+CaO+MgO, and/or 1 mol % to 20 mol % of La₂O₃+Gd₂O₃+Y₂O₃, and/or 2 mol % to 14 mol % of B₂O₃+La₂O₃, and/or 1 mol % to 12 mol % of B₂O₃+Al₂O₃.

4. The optical glass of claim 1, comprising 30 mol % to 41 mol % of SiO₂+B₂O₃, and/or 29 mol % to 40 mol % of SiO₂+ZrO₂, and/or 15 mol % to 35 mol % of BaO+SrO+CaO+MgO, and/or 1.5 mol % to 15 mol % of La₂O₃+Gd₂O₃+Y₂O₃, and/or 4 mol % to 12 mol % of B₂O₃+La₂O₃, and/or 3 mol % to 10 mol % of B₂O₃+Al₂O₃.

5. The optical glass of claim 1, wherein the components of the optical glass satisfy one or more of the following molar ratios:
1) SiO₂/B₂O₃ from 3.5 to 38.0;
2) (SiO₂+ZrO₂)/(B₂O₃+Li₂O) from 1.8 to 15.0;
3) (Nb₂O₅+TiO₂+WO₃+Bi₂O₃+Ta₂O₅)/(SiO₂+B₂O₃) from 0.3 to 1.8;
4) TiO₂/(Nb₂O₅+La₂O₃) from 0.35 to 3.2;
5) CaO/(BaO+SrO+CaO+MgO) from 0.25 to 0.95; or
6) BaO/(BaO+SrO+CaO+MgO) from 0.03 to 0.5.

6. The optical glass of claim 1, wherein the components of the optical glass satisfy one or more of the following molar ratios:
1) SiO₂/B₂O₃ from 4.0 to 30.0;
2) (SiO₂+ZrO₂)/(B₂O₃+Li₂O) from 2.0 to 10.0;
3) (Nb₂O₅+TiO₂+WO₃+Bi₂O₃+Ta₂O₅)/(SiO₂+B₂O₃) from 0.5 to 1.4;
4) TiO₂/(Nb₂O₅+La₂O₃) from 0.5 to 2.8;
5) CaO/(BaO+SrO+CaO+MgO) from 0.4 to 0.7; or
6) BaO/(BaO+SrO+CaO+MgO) from 0.05 to 0.3.

7. The optical glass of claim 1, comprising the following components: 27 mol % to 38 mol % of SiO₂, and/or 2 mol % to 7 mol % of B₂O₃, and/or 2 mol % to 7 mol % of La₂O₃, and/or 1.5 mol % to 5 mol % of BaO, and/or 7 mol % to 22 mol % of CaO, and/or 6 mol % to 14 mol % of Nb₂O₅, and/or 9 mol % to 19 mol % of TiO₂, and/or 2 mol % to 13 mol % of Li₂O, and/or 0 mol % to 3 mol % of Al₂O₃, and/or 0 mol % to 6 mol % of Gd₂O₃, and/or 0 mol % to 6 mol % of Y₂O₃, and/or 1 mol % to 14 mol % of SrO, and/or 0 mol % to 8 mol % of MgO, and/or 0 mol % to 6 mol % of ZnO, and/or 0 mol % to 4 mol % of ZrO₂, and/or 0 mol % to 2 mol % of WO₃, and/or 0 mol % to 2 mol % of Bi₂O₃, and/or 0 mol % to 2 mol % of Ta₂O₅, and/or 0 mol % to 8 mol % of Na₂O, and/or 0 mol % to 8 mol % of K₂O, and/or 0 mol % to 0.5 mol % of Sb₂O₃.

8. The optical glass of claim 1, comprising the following components: 29 mol % to 36 mol % of SiO₂, and/or 3 mol % to 6 mol % of B₂O₃, and/or 3 mol % to 6 mol % of La₂O₃, and/or 2 mol % to 4 mol % of BaO, and/or 9 mol % to 20 mol % of CaO, and/or 7 mol % to 13 mol % of Nb₂O₅, and/or 10 mol % to 18 mol % of TiO₂, and/or 3 mol % to 11 mol % of Li₂O, and/or 0 mol % to 4 mol % of Gd₂O₃, and/or 0 mol % to 4 mol % of Y₂O₃, and/or 2 mol % to 12 mol % of SrO, and/or 0 mol % to 5 mol % of MgO, and/or 0 mol % to 4 mol % of ZnO, and/or 0 mol % to 3 mol % of ZrO₂, and/or 0 mol % to 6 mol % of Na₂O, and/or 0 mol % to 6 mol % of K₂O, and/or 0 mol % to 0.2 mol % of Sb₂O₃, and/or 0 mol % of Al₂O₃, and/or 0 mol % of WO₃, and/or 0 mol % of Bi₂O₃, and/or 0 mol % of Ta₂O₅.

9. The optical glass of claim 1, wherein the optical glass has a refractive index (n_{d}) of 1.87 to 1.93, and/or an Abbe number (v_{d}) of 24 to 30, and/or a relative partial dispersion (P_{g,F}) of smaller than or equal to 0.6090, and/or an internal transmittance (τ₄₀₀) of 0.68 or higher, and/or a climate resistance of class 2 or higher, and/or an acid resistance of class 2 or higher, and/or a density of 3.90 g/cm³ or smaller.

10. The optical glass of claim 1, wherein the optical glass has a refractive index (n_{d}) of 1.89 to 1.91, and/or an Abbe number (v_{d}) of 26 to 28, and/or a relative partial dispersion (P_{g,F}) of smaller than or equal to 0.6080, and/or an internal transmittance (τ₄₀₀) of 0.72 or higher, and/or a climate resistance of class 1, and/or an acid resistance of class 1, and/or a density of 3.85 g/cm³ or smaller.

11. The optical glass of claim 1, consisting of the following components: 25 mol % to 40 mol % of SiO₂, 1 mol % to 8 mol % of B₂O₃, 1 mol % to 8 mol % of La₂O₃, 1 mol % to 6 mol % of BaO, 5 mol % to 25 mol % of CaO, 5 mol % to 15 mol % of Nb₂O₅, 8 mol % to 20 mol % of TiO₂, 1.5 mol % to 15 mol % of Li₂O, 0 mol % to 5 mol % of Al₂O₃, 0 mol % to 8 mol % of Gd₂O₃, 0 mol % to 8 mol % of Y₂O₃, 0 mol % to 15 mol % of SrO, 0 mol % to 10 mol % of MgO, 0 mol % to 8 mol % of ZnO, 0 mol % to 5 mol % of ZrO₂, 0 mol % to 5 mol % of WO₃, 0 mol % to 5 mol % of Bi₂O₃, 0 mol % to 5 mol % of Ta₂O₅, 0 mol % to 10 mol % of Na₂O, 0 mol % to 10 mol % of K₂O, and 0 mol % to 1 mol % of Sb₂O₃.

12. A glass preform prepared from the optical glass of claim 1.

13. An optical element prepared from the optical glass of claim 1 or a glass preform prepared from the optical glass of claim 1.

14. An optical device, comprising the optical glass of claim 1, or an optical element prepared from the optical glass of claim 1, or an optical element prepared from a glass preform prepared from the optical glass of claim 1.
